(19) United States
(12) Patent Application Publication
(10) Pub. No.: US 2014/0151076 A1
(43) Pub. Date: Jun. 5, 2014

(54) Apparatus to move in tow farm implements

(71) Applicant: Walter W. DEAN, Alpharetta, GA (US)

(72) Inventor: Walter W. DEAN, Alpharetta, GA (US)

(21) Appl. No.: 13/694,474

(22) Filed: Dec. 5, 2012

(51) Int. Cl. A01B 59/02; A01B 63/14

(52) U.S. Cl. CPC A01B 59/02; A01B 63/14
USPC 172/438; 172/495; 172/496

(57) ABSTRACT

An apparatus to move in-tow at least one farm implement. The apparatus is an elongated rectangular member that has a first end and a second end opposite the first end. A movement transfer mechanism is connected between the elongated rectangular member's first end and the farm implement. The apparatus has a first wheel mounted on one side of the elongated rectangular member's first end and a second wheel mounted on the other side of the elongated rectangular member's first end. A third wheel is mounted adjacent to the second end of the elongated rectangular member. The wheels may, if desired, be ground engaging wheels.

### BACKGROUND OF THE INVENTION

Modern farm machinery is generally fueled by gasoline or diesel. The availability and price of gasoline or diesel does not present a problem for farmers in developed countries. The availability of farm equipment such as tractors and farm implements in less developed countries, e.g.; Africa and Central America, it a very big obstacle. Often these countries lack the infrastructure to transport fuel to the farms located in rural areas. The type of farming done in these areas is limited to traditional farming i.e., a one bladed plow that is pulled by a farm animal and the availability of capitol and credit in these areas.

The farmer's productivity is low and the farm plots are small because they are subject to adverse conditions mainly poverty, weather and the farming season is relatively short due to the rainy season. The only way a farmer can increase his productivity is to work longer hours. It would be desirable to have an apparatus that is not powered by fuel and has a plurality of plow blades so that a farmer can increase his productivity. Other possibilities of such an apparatus to move in-tow farm implements like this are endless.

### SUMMARY OF THE INVENTION

The present invention is an apparatus to move in-tow at least one farm implement. The apparatus is an elongated rectangular member that has a first end and a second end opposite the first end. A movement transfer mechanism is connected between the elongated rectangular member's first end and the farm implement. The apparatus has a first wheel mounted on one side of the elongated rectangular member's first end and a second wheel mounted on the other side of the elongated rectangular member's first end. A third wheel is mounted adjacent to the second end of the elongated rectangular member. The wheels may, if desired, be ground engaging wheels.

### BRIEF DESCRIPTION OF THE DRAWINGS

The invention is illustrated in the drawings in which like reference characters designate the same or similar parts throughout the figures of which:

FIG. 1 illustrates a top-level schematic diagram view of an apparatus to move in-tow farm implements,

FIG. 2 illustrates a top-level schematic diagram view of an elongated rectangular member of FIG. 1 with a lifting and lowering mechanism,

FIG. 3 illustrates a top-level schematic diagram view of an elongated rectangular member of FIG. 1 with a braking mechanism that controls the directional movement of the apparatus,

FIG. 4 illustrates a top-level schematic diagram view of an elongated rectangular member of FIG. 1, with a lifting mechanism and a lifting assist lever, and

FIG. 5 illustrates a top-level schematic diagram side view of an elongated rectangular member of FIGS. 3 and 4 with the lifting mechanism assist lever and the controls for the braking mechanism.

### DETAILED DESCRIPTION OF THE INVENTION

Before describing in detail the particular improved apparatus for move in-tow farm implements in accordance with the present invention, it should be observed that the invention resides primarily in the novel structural combination of conventional mechanical components and in the particular detailed configuration thereof. Accordingly, the apparatus arrangement has, for the most part, been illustrated in the drawings by readily understandable schematic diagrams. The drawings illustrate only those specific details that are pertinent to the present invention in order not to obscure the disclosure with structural details which will be readily apparent to those skilled in the art having the benefit of the description herein.

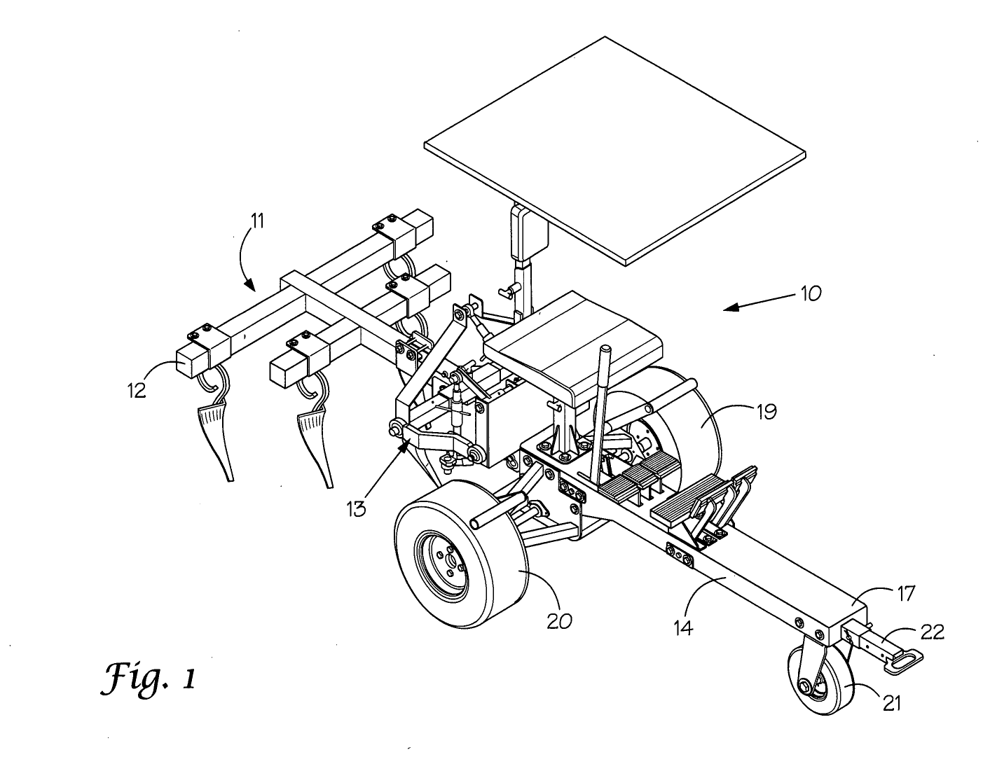

The present invention 10, FIG. 1 is an apparatus to move in-tow at least one farm implement 11. The apparatus 10 is an elongated rectangular member 14 that has a first end 16 and a second end 17 opposite the first end 16. A movement transfer mechanism 13 is connected between the elongated rectangular member's 14 first end 16 and the farm implement 12. The apparatus 10 has a first wheel 19 mounted on one side of the elongated rectangular member's 14 first end 16 and a second wheel 20 mounted on the other side of the elongated rectangular member's 14 first end 16. A third wheel 21 is mounted adjacent the second end 17 of the elongated rectangular member 14. The wheels 19, 20 and 21 may, if desired, be ground engaging wheels.

An adjustable towing hitch 22 mounted at the elongated rectangular member's 14 second end 17. A first towing hitch 22 may, if desired, have an aperture that functions as a securing point for at least one animal of sufficient size to pull the apparatus 10. An example, of an animal of sufficient size is an ox.

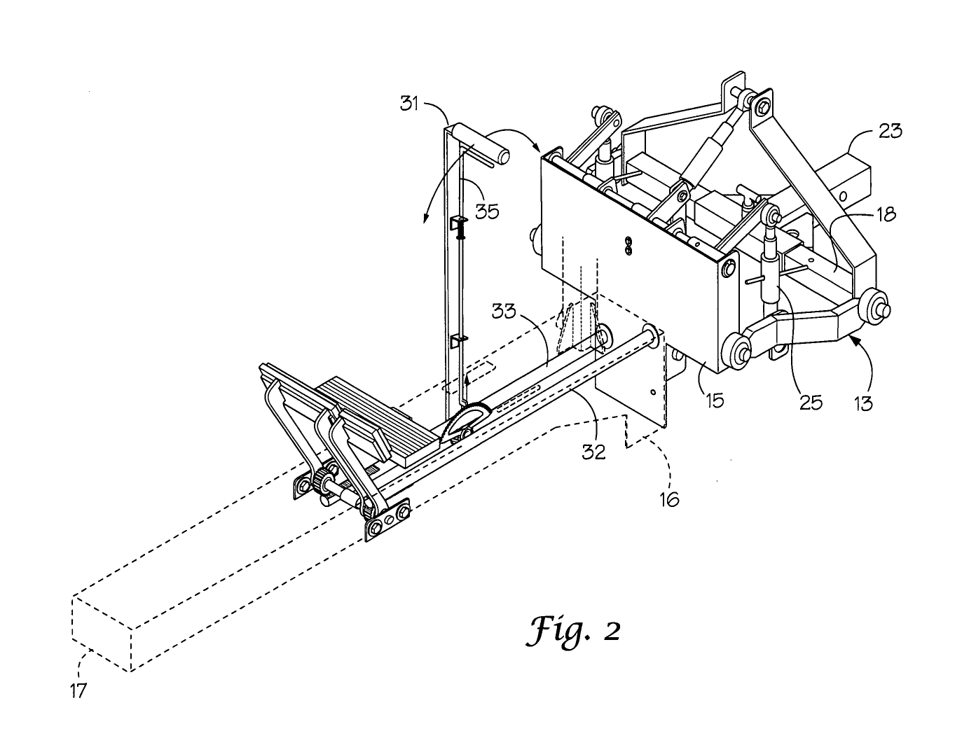

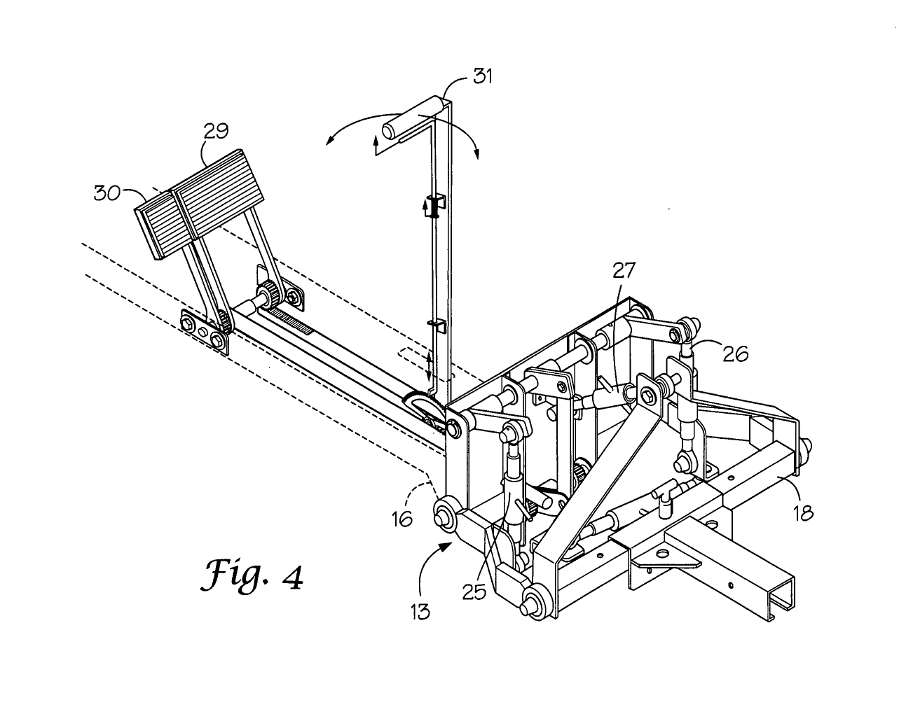

The farm implement 11, FIG. 1 is connected to a movement transfer mechanism 13 that is connected to a first end 16, of the elongated substantially rectangular member 14. The movement transfer mechanism 13 has an upright C-shaped member 15 connected to a pivotal crossbar 18, FIG. 2. The pivotal crossbar 18 is connected to a second hitch 23 that is the connection point for the farm implement 12. The movement transfer mechanism 13 has a plurality of turnbuckles 25, 26, 27 and 28, FIG. 4 that set the maximum and minimum range of pivot the crossbar 18, FIG. 2 may move. The turnbuckle 28 sets the maximum and minimum range of side to side movement of the crossbar 18, FIG. 2.

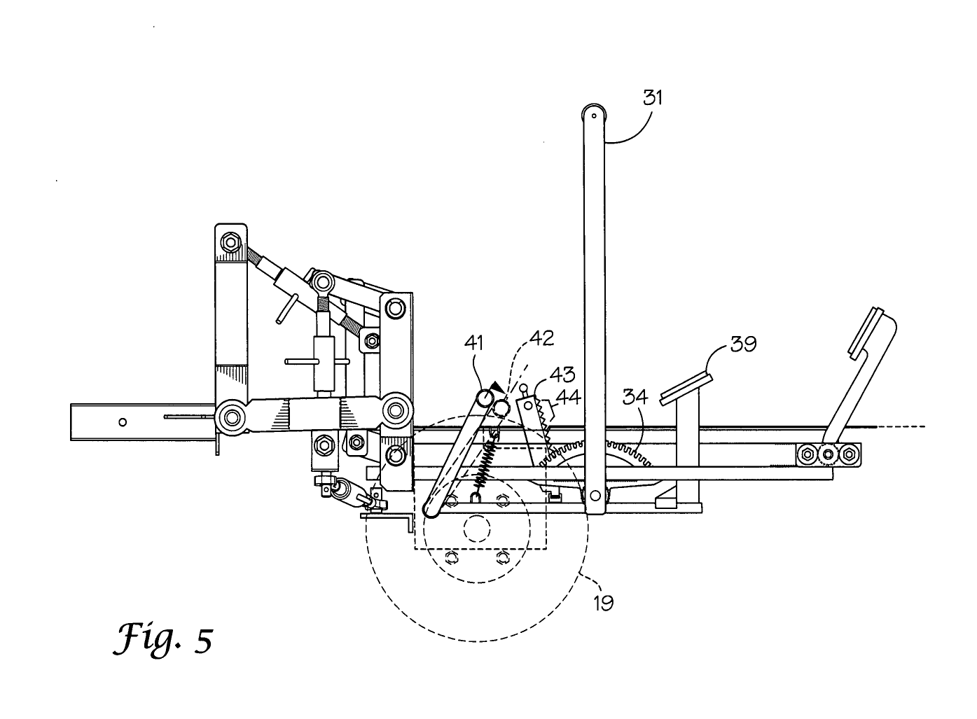

The movement transfer mechanism 13, FIG. 4 has a pair of pedals 29 and 30 adjacently spaced from the elongated rectangular member's 14 first end 16. The pair of pedals 29 and 30 are connected to the movement transfer mechanism 13 via a pair of elongated rods 32 and 33. Depressing pedal 30, connected to rod 32, lowers the movement transfer mechanism 13 to its maximum range set by the turnbuckles 25 and 26. Depressing pedal 29, connected to rod 33, raises the movement transfer mechanism 13 to its minimum range set by the turnbuckle 27. A first elongated L-shaped assist lever 31 is connected to rod 33 via a ratchet 34, FIG. 5. The ratchet 34 assists the upwards movement of the movement transfer mechanism 13. The ratchet 34 sets and holds the movement transfer mechanism 13, by and extension the farm implement 11, in a selected position via a second elongated L-shaped member 35, FIG. 2. The second elongated L-shaped member 35 is movably disposed to the first elongated L-shaped assist lever member 35.

The first elongated L-shaped assist lever member 35, FIG. 2 has a first position all the way forward towards the second end 17 of the elongated rectangular member 14. The first position places the movement transfer mechanism 13 to its maximum range by turnbuckles 26 and 27 i.e., the farm implement 11 is resting on the ground. The first elongated L-shaped assist lever member 35, FIG. 2 has a second position all the way backwards towards the first end 16 of the elongated rectangular member 14. When the pedal 29 is depressed the elongated L-shaped assist lever member 35 may, if desired, moved from first position towards the second position thereby assisting in the lifting of the movement transfer mechanism 13 from its maximum position to its minimum position. The movement transfer mechanism 13 may, if desired, be locked in place by the second elongated L-shaped assist lever member 35.

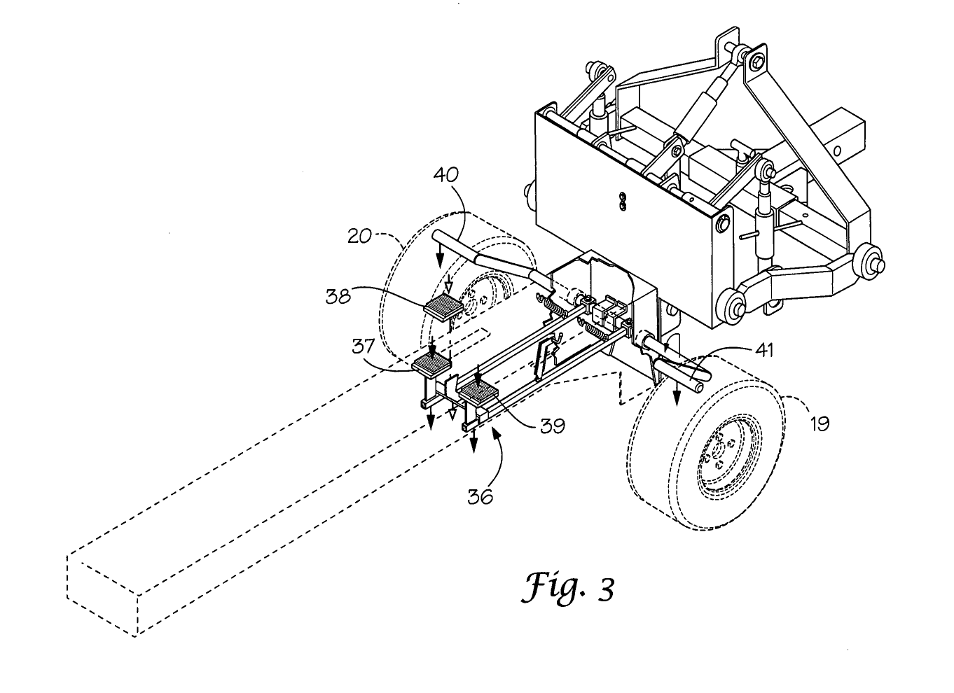

A braking mechanism 36, FIG. 3 controls the directional movement of the apparatus 10. The braking mechanism 36 has three pedals 37, 38 and 39 and a brake adjustment rectangular bar 43 that are adjacently spaced from the elongated rectangular member's 14 second end 17. The pedal 37 is connected to an elongated rod 40 that is juxtaposition wheel 20. When the pedal 37 is depressed the elongated rod 40 moves downward to engage wheel 20. The pressure of the elongated rod 40 on wheel 20 stops the forward movement of the apparatus 10 and turns the apparatus 10 to the right. Pedal 39 is connected to an elongated rod 41 that is juxtaposition wheel 19. When the pedal 39, FIG. 5 is depressed the elongated rod 41 moves downward 42, FIG. 5 to engage wheel 19 and stop the forward movement of the apparatus 10 and turns the apparatus 10 to the left. The center pedal 38 is connected to pedals 37 and 39 and when depressed applies pressure to elongated rods 40 and 41 onto wheels 19 and 20 and stops the forward movement of the apparatus 10. The rectangular bar 43 has teeth along one edge 44, FIG. 5. The teeth 44, engage a protuberance on the brake pedals 37, 38 and 39 to set the distance between rods 40 and 41 to the wheels 19 and 20.

The apparatus 10 may, if desired, be manufactured out of sheet steel, rigid plastic, aluminum or any other convenient material that is sufficiently rigid to tow farm implements and to be towed by something other than machinery. The farm implements may, if desired, be a plow 12, a disk or a plurality of different farm implements.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. A means-plus-function clause is intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I Claim:

1) Apparatus to move in-tow farm implements comprising:
a) a plurality of wheels connectively disposed to the apparatus;
b) an elongated substantially rectangular member having a first end and a second end oppositely disposed from said first end, said first end connectively disposed to two of said plurality of wheels, said second end connectively disposed to one of said plurality of wheels; and
c) a plurality of pedals adjacently spaced from said first end, said pedals connectively disposed to two of said plurality of wheels via a braking mechanism, said braking mechanism controls directional movement of the apparatus.

2) Apparatus to move in tow farm implements comprising:
a) an elongated substantially rectangular member having a first end and a second end oppositely disposed from said first end, said first end connectively disposed to two of said plurality of wheels;
b) a pair of pedals adjacently spaced from said second end, one of said pedals controls upward movement of the farm implements;
c) another pedal of said pair of pedals controls downward movement of the farm implements; and
d) an elongated assist lever adjacently spaced from said pair of pedals along said elongated substantially rectangular member, said elongated assist lever assists said upward movement of the farm implements via a ratchet mechanism, said ratchet mechanism aids in control of the farm implements.

3) Apparatus to move in tow farm implements comprising:
a) an elongated substantially rectangular member having a first end and a second end oppositely disposed from said first end, said first end connectively disposed to a pair of wheels;
b) a pair of pedals adjacently spaced from said second end, one of said pedals controls upward movement of the farm implements;
c) another pedal of said pair of pedals controls downward movement of the farm implements;
d) a movement transfer mechanism connectively disposed between said pair of pedals and the farm implements;
e) a plurality of turnbuckles connectively disposed to said movement f) said upward movement lifts the farm implements via said movement transfer mechanism; and
g) said downward movement lowers the farm implements via said movement transfer mechanism.

4) The apparatus as recited in claim 1 wherein said pair of wheels comprises two wheels connectively disposed on either side of said elongated substantially rectangular member, said two wheels adjacently spaced from said first end and one wheel connectively disposed to said second end.

5) The apparatus as recited in claim 1 wherein said plurality of pedals comprises three pedals disposed in a row adjacently spaced from said first end.

6) The apparatus as recited in claim 1 wherein said braking mechanism further comprising :
a) a right, left and center pedal adjacently spaced from said first end;
b) a first rigid elongated bar connectively disposed above to one of said plurality of wheels;
c) a second rigid elongated bar connectively disposed above another one of said plurality of wheels;
d) said first rigid elongated bar connectively disposed to said right pedal whereby when said right pedal is depressed it locks one of said plurality of wheels and turns the apparatus to the right;
e) said second rigid elongated bar connectively disposed to said left pedal, whereby when said left pedal is depressed it locks one of said plurality of wheels and turns the apparatus to the left; and
f) said center pedal connectively disposed to said right and said left pedal whereby when said center pedal is depressed it locks two of the plurality of wheels and stops the forward movement of the apparatus.
